(19) United States
(12) Patent Application Publication
(10) Pub. No.: US 2026/0012507 A1
(43) Pub. Date: Jan. 8, 2026

(54) LOCALLY PROVIDED CLOUD-BASED SERVICES FOR DARKSITE ENVIRONMENTS

(71) Applicant: PURE STORAGE, INC., SANTA CLARA, CA (US)

(72) Inventors: MARTIN VICH, VYSOKÝ ÚJEZD (CZ); BENJAMIN BOROWIEC, SARATOGA, CA (US)

(21) Appl. No.: 19/324,740

(22) Filed: Sep. 10, 2025

Related U.S. Application Data
(63) Continuation-in-part of application No. 18/355,270, filed on Jul. 19, 2023.
Application No. 18/355,270 is a continuation of application No. 17/389,457, filed on Jul. 30, 2021, now Pat. No. 11,711,426.

(51) Int. Cl. H04L 67/1097; H04L 67/1001; H04L 67/56

(52) U.S. Cl. CPC H04L 67/1097; H04L 67/1001; H04L 67/56

(57) ABSTRACT

Operational data is received from one or more storage systems by an internal server deployed within an environment lacking external connectivity. The operational data is processed by the internal server to determine a state of the one or more storage systems. Information identifying one or more maintenance actions applicable to the one or more storage systems is generated based on the determined state.

### CROSS-REFERENCE TO RELATED APPLICATIONS

This is a continuation in-part application entitled to a filing date and claiming the benefit of U.S. Ser. No. 18/355,270, filed Jul. 19, 2023, which is herein incorporated by reference in its entirety, which is a continuation application of U.S. Pat. No. 11,711,426, issued Jul. 25, 2023, which is a continuation of U.S. Pat. No. 11,102,298, issued Aug. 24, 2021, which is a continuation in-part of U.S. Pat. No. 10,652,331, issued May 12, 2020, which is a continuation of U.S. Pat. No. 10,027,757, issued Jul. 17, 2018, which is a continuation of U.S. Pat. No. 9,716,755, issued Jul. 25, 2017.

### BRIEF DESCRIPTION OF THE DRAWINGS

FIG. 1 sets forth a block diagram of a system configured for providing storage array services first in the cloud then locally according to embodiments of the present invention.

FIG. 2 sets forth a block diagram of several example computers useful for providing cloud storage array services according first in the cloud then locally according to embodiments of the present invention.

FIG. 3 sets forth a block diagram of an example storage controller of a storage array useful for locally providing cloud storage array services.

FIG. 4 sets forth an example block diagram of a system that locally provides cloud storage array services in accordance with embodiments of the present invention.

FIG. 5 sets forth a flow chart illustrating an exemplary method of locally providing cloud storage array services according to embodiments of the present invention.

FIG. 6 sets forth a flow chart illustrating another method of locally providing cloud storage array services in accordance with embodiments of the present invention.

FIG. 7 sets forth a flow chart illustrating another method of locally providing cloud storage array services in accordance with embodiments of the present invention.

FIG. 8A depicts a computing environment that includes an implementation of an integrated storage manager in accordance with embodiments of the present invention.

FIG. 8B depicts a computing environment that includes an implementation of an integrated storage manager in accordance with embodiments of the present invention.

FIG. 9 sets forth a flow chart illustrating a method of locally providing cloud storage array services in accordance with embodiments of the present invention.

FIG. 10 is an illustration of an example architecture including internal server that provides maintenance actions for one or more storage systems deployed within a darksite environment, in accordance with embodiments of the disclosure.

FIG. 11 is an illustration of an example architecture in which internal server exchanges information with external service through use of a report, in accordance with embodiments of the disclosure.

FIG. 12 is an example method illustrating an example method of propagating aggregated operational data to external service when connectivity becomes available, in accordance with embodiments of the disclosure.

FIG. 13 is an example method illustrating an example method of generating maintenance actions from operational data in accordance with embodiments of the disclosure.

### DESCRIPTION OF EMBODIMENTS

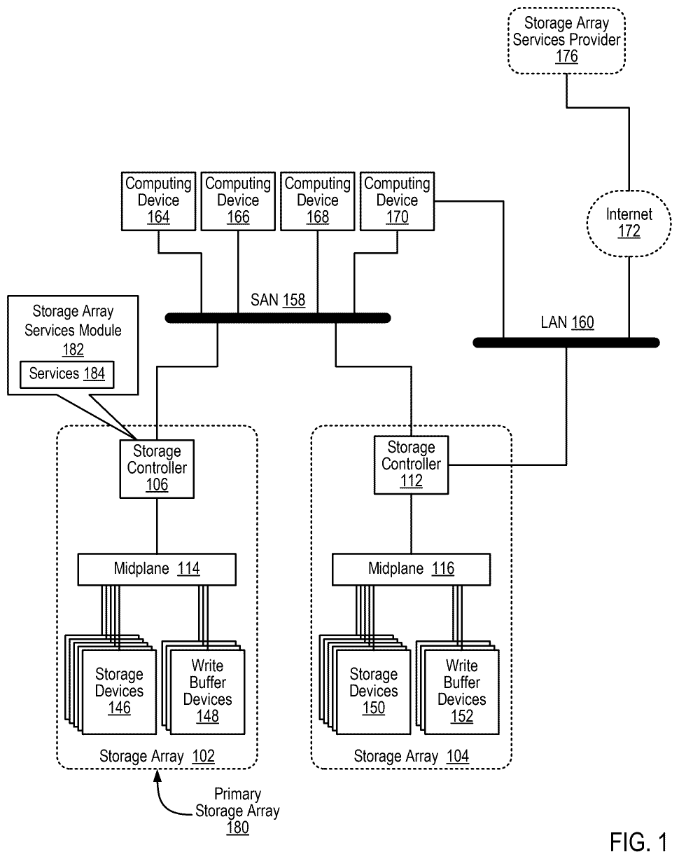

Exemplary methods, apparatus, and products for providing cloud storage array services for a storage array of a data center when the storage array is not connected to a remote cloud-based storage array services provider in accordance with the present invention are described with reference to the accompanying drawings, beginning with FIG. 1. The term ‘cloud’ as used in this specification refers to systems and computing environments that provide services to user devices through the sharing of computing resources through a network. Generally, the user device is unaware of the exact computing resources utilized by the cloud system to provide the services. Although in many cases such ‘cloud’ environments or systems are accessible via the Internet, readers of skill in the art will recognize that any system that abstracts the use of shared resources to provide services to a user through any network may be considered a cloud-based system.

FIG. 1 sets forth a block diagram of a system configured for locally providing cloud storage array services according to embodiments of the present invention. The system of FIG. 1 includes a number of computing devices (164, 166, 168, 170). Such computing devices may be implemented in a number of different ways. For example, a computing device may be a server in a data center, a workstation, a personal computer, a notebook, or the like.

The computing devices (164-170) in the example of FIG. 1 are coupled for data communications to a number of storage arrays (102, 104) through a storage area network (SAN) (158) as well as a local area network (160) (LAN). The SAN (158) may be implemented with a variety of data communications fabrics, devices, and protocols. Example fabrics for such a SAN may include Fibre Channel, Ethernet, Infiniband, SAS (Serial Attached Small Computer System Interface), and the like. Example data communications protocols for use in such a SAN (158) may include ATA (Advanced Technology Attachment), Fibre Channel Protocol, SCSI, ISCSI, HyperSCSI, and others. Readers of skill in the art will recognize that a SAN is just one among many possible data communications couplings which may be implemented between a computing device and a storage array. Any other such data communications coupling is well within the scope of embodiments of the present invention.

The local area network (160) of FIG. 1 may also be implemented with a variety of fabrics and protocols. Examples of such fabrics include Ethernet (802.3), wireless (802.11), and the like. Examples of such data communications protocols include TCP (Transmission Control Protocol), UDP (User Datagram Protocol), IP (Internet Protocol), HTTP (HyperText Transfer Protocol), WAP (Wireless Access Protocol), HDTP (Handheld Device Transport Protocol), SIP (Session Initiation Protocol), RTP (Real Time Protocol) and others as will occur to those of skill in the art.

The example storage arrays (102, 104) of FIG. 1 provide persistent data storage for the computing devices. Each storage array (102, 104) includes a storage controller (106, 112). The storage controller is a module of automated computing machinery comprising computer hardware, computer software, or a combination of computer hardware and software. The storage controller may be configured to carry out various storage-related tasks. Such tasks may include writing data received from a computing device to storage, erasing data from storage, retrieving data from storage to provide to a computing device, monitoring and reporting of disk utilization and performance, performing RAID (Redundant Array of Independent Drives) or RAID-like data redundancy operations, compressing data, encrypting data, and so on.

Each storage controller (106, 112) may be implemented in a variety of ways, including as an FPGA (Field Programmable Gate Array), a PLC (Programmable Logic Chip), an ASIC (Application Specific Integrated Circuit), or computing device that includes discrete components such as a central processing unit, computer memory, and various adapters. Each storage controller (106, 112) may, for example, include a data communications adapter configured to support communications via the SAN (158) and the LAN (160). For clarity, only one of the storage controllers (112) in the example of FIG. 1 is depicted as coupled to the LAN (160) for data communications. Readers should understand that both storage controllers (106, 112) are independently coupled to the LAN (160). Each storage controller (106, 112) may also, for example, include an I/O controller or the like that couples the storage controller (106, 112) for data communications, through a midplane (114), to a number of storage devices (146, 150), and a number of write buffer (148, 152) devices.

Each write buffer device (148, 152) may be configured to receive, from the storage controller (106, 112), data to be stored in the storage devices (146). Such data may originate from any one of the computing devices (164-170). In the example of FIG. 1, writing data to the write buffer device may be carried out more quickly than writing data to the storage device. The storage controller (106, 112) may be configured to effectively utilize the write buffer devices (148, 152) as a quickly accessible redundant buffer for data destined to be written to storage. In this way, if the storage device to which the data is to be written fails or if the write does not complete, the write buffer device may maintain the data to be written during a retry of the write or during failover of the storage device to another location. That is, the write buffer device may provide redundancy for the storage devices.

A ‘storage device’ as the term is used in this specification refers to any device configured to record data persistently. The term ‘persistently’ as used here refers to a device's ability to maintain recorded data after loss of a power source. Examples of storage devices may include mechanical, spinning hard disk drives, Solid-state drives (“Flash drives”), and the like.

In addition to being coupled to the computing devices through the SAN (158), the storage arrays may also be coupled to the computing devices through the LAN (160) and to one or more cloud service providers through the Internet (172). One example cloud service in FIG. 1 is a storage array services provider (176). The storage array service provider (176) may be configured to provide various storage array services (184) such as reporting of storage array performance characteristics, configuration control of the storage arrays, and the like. The storage array services provider may rely on modules executing on the storage array itself to gather or process such data.

In some instances, the storage arrays (102, 104) may be disconnected from the storage array services provider (176). Various reasons may exist for such a disconnect. For example, a loss of data communications connection between the storage array and the storage array services provider (176) may occur. In high-security data centers, as another example, the storage arrays (102, 104) may never be connected to the storage array services provider at all. In such situations, users may still desire the services provided by the storage array services provider. To that end, the system of FIG. 1 may be configured, according to embodiments of the present invention, to locally provide cloud storage array services for a storage array of a data center when the storage array is not connected to a remote cloud-based storage array services provider. Such local providing of the cloud storage array services may be carried out by a storage array services module (182) of one of the storage arrays (102, 104), referred to here as the ‘primary’ storage array (180). The storage array services module (182) is a module of automated computing machinery comprising computer hardware, computer software, or a combination of computer hardware and software. The storage array services module (182) may locally provide the cloud storage array services by initiating one or more cloud storage array services (184) and locally providing the cloud storage array services. Providing the cloud storage array services locally may include generating, by the cloud storage array services (184), metadata describing one or more real-time storage array characteristics and presenting the metadata to a user through a local area network (160). ‘Metadata’ as the term is used in this specification refers to data that describes various characteristics of the storage array. Such data may take on various forms in dependence upon the types of cloud storage array services executing on the storage array. Some examples of such services may include a service that tracks and reports the rate and type of access of the storage devices of the storage array, a service that tracks and reports throughput of the storage array, a service that monitors and reports memory wear leveling of the storage devices, a service that reports capacity utilization of the storage devices, a service that reports deduplication statistics, a service that reports RAID (Redundant Array of Independent Drives) statistics, a service that reports logical volume statistics, a service that monitors and reports power consumption of the storage array, and other services as will occur to readers of skill in the art.

Prior to presentation, the metadata may be processed and analyzed. Such analysis processing and analysis may also be included in the presentation of the metadata to the user through the LAN (160). That is, ‘presenting the metadata’ is not limited to presenting the metadata in its original form. The metadata may be formatted, processed, analyzed, and otherwise altered for purposes of presentation.

As mentioned above, one example in which cloud storage array services are provided locally in accordance with embodiments of the present invention includes when a loss of data communications occurs. To that end, the primary storage array (180), through the storage array services module (182) may be configured to detect a data communications connection between the primary storage array (180) and a remote cloud-based storage array services provider (176). Here, a ‘heartbeat’ signal may be used to ensure that the data communications connection between the primary storage array (180) and the cloud-based storage array services provider (176) is maintained. Such a ‘heartbeat’ may be a periodic ping of the storage array services provider. As long as the ping is returned, the storage array services module (182) may infer that the data communications connection between the storage array services provider (176) and the primary storage array (180) has not been lost. In such an embodiment, the cloud-based storage array services provider (176) may provide the cloud storage array services remotely, rather than the storage array services module (182).

Further, while the data communications connection between the primary storage array (180) and the storage array services provider (176) is active, the storage array services module (182) may periodically retrieve, from the remote cloud-based storage array services provider (176), a current configuration of the cloud storage array services and the current configuration of the plurality of storage arrays (102, 104) in the data center. The term ‘current configuration of the cloud storage array services’ may include any data related to the execution of the services including, for example, a list of the types of services to be executed, the executable computer program instructions of the services themselves, updates to the executable computer program instructions of the services, data used to seed the services, data describing the format of presenting the results of the services, and so on. The term ‘current configuration of the plurality of storage arrays’ refers to any data describing each of the storage arrays of the data center including: storage capabilities of each storage array; data communications capabilities, endpoints, and present connectivity of each storage array; one or more identifiers of the storage array or the array's components; a listing of components of the storage array; an identification of logical volumes maintained by the storage array; and the like. By periodically updating these current configurations, the storage array services module (182) may be primed to locally provide the cloud storage array services upon a loss of data communications between the primary storage array (180) and the storage array services provider (176).

The storage array services module (182) may later detect loss of the data communications connection between the primary storage array and the remote cloud-based storage array services provider. The storage array services module (182) may detect such a loss of communications when a predefined number of pings of the heartbeat signal are not returned. Responsive to detecting the loss of communications between the primary storage array (180) and the storage array services provider (176), the storage array services provider may then initiate the cloud storage array services (184).

In embodiments in which multiple storage arrays are included in the data center, each storage array may be independently coupled for data communications to the cloud-based storage array services provider (176). In such embodiments, each storage array is generally unaware of the other storage arrays at least for purposes of participating in storage array services offered by the cloud-based storage array services provider (176). In such an embodiment, the cloud-based storage array services provider may expose a REST (Representational State Transition) API (Application Programming Interface), or the like, to the storage arrays to carry out data communications between a storage array service and a storage array. REST APIs generally utilize HTTP commands and a domain as the basis for data communications to between two endpoints. To that end, upon a loss of communications with the cloud-based storage array services provider (176), the primary storage array (180) may initiate the one or more cloud storage array services (184) by altering a local DNS (Domain Name Service) record such that the domain originally utilized by the cloud-based storage array services provider (176) redirects to an IP address of the primary storage array. In this way, any communications that would normally be addressed to the cloud-based storage array services provider from any storage array in the data center are now redirected to the primary storage array (180).

In such an embodiment in which multiple storage arrays are located within a single data center, generating metadata describing one or more real-time storage array characteristics may also include generating metadata describing one or more real-time storage array characteristics of each of the plurality of the storage arrays; and aggregating, for presentation to the user, the metadata of each of the plurality of storage arrays.

Although the example of FIG. 1 depicts the primary storage array (180) as the host of the cloud storage array services (184), other storage arrays may host the services in various circumstances. In this way, initiating the one or more cloud storage array services may also include selecting, by the primary storage array through the storage array services module (182) one of the plurality of storage arrays in the data center to host the one or more cloud storage array services in dependence upon workload characteristics of each of the plurality of storage arrays. The term ‘workload characteristics’ here refers to any metric that may be utilized to infer availability of processing capabilities. Examples of such workload characteristics may include processing capabilities of each storage array (CPU speed, memory bus speed, and the like), a history of storage access operations over a predefined period of time, status of a job queue directed to accessing a volume hosted on a storage array, and so on as will occur to readers of skill in the art. That is, a storage array with less workload than all other storage arrays may be utilized to host the cloud storage array services (184) so that primary data storage operations are unaffected.

In embodiments in which workload characteristics are utilized to select a host for the cloud-based storage array services, the primary storage array (180) may also be configured to detect a change in workload characteristics of each of the plurality of storage arrays. Such a change may be detected in a variety of ways including, for example, by detecting a failure of a storage array, by periodically retrieving workload characteristics, and so on. Upon detecting the change, the primary storage array (180) may then re-select one of the storage arrays to host the one or more cloud storage array services in dependence upon the changed workload characteristics. In this way, hosting of the services may be dynamically reassigned when workload changes amongst the storage arrays.

In embodiments in which a storage array other than the primary storage array (180) is selected to host the cloud-based storage array services, the primary storage array may operate as a proxy for the selected storage array. In such an embodiment, presenting the metadata to a user through a local area network may include presenting the metadata through the proxy of the primary storage array. The primary storage array (180) may operate as a proxy in different ways. In one way, the primary storage array receives only the final aggregated results for presentation to the user through the local area network (160). That is, the selected storage array actually hosting the cloud-based storage array services (184) may perform the services, collecting metadata from all storage arrays, aggregate the metadata into a single result and pass that result on to the primary storage array for presentation to a user. In another example, the selected storage array may execute the cloud-based storage array services and each storage array may pass its metadata directly to the primary storage array. In such an embodiment, the primary storage array may aggregate and process the metadata of each storage array prior to presenting the aggregated and processed metadata to a user through the LAN (160).

The arrangement of computing devices, storage arrays, cloud-based service providers, networks and other devices making up the exemplary system illustrated in FIG. 1 are for explanation, not for limitation. Systems useful according to various embodiments of the present invention may include different configurations of servers, routers, switches, computing devices, and network architectures, not shown in FIG. 1, as will occur to those of skill in the art.

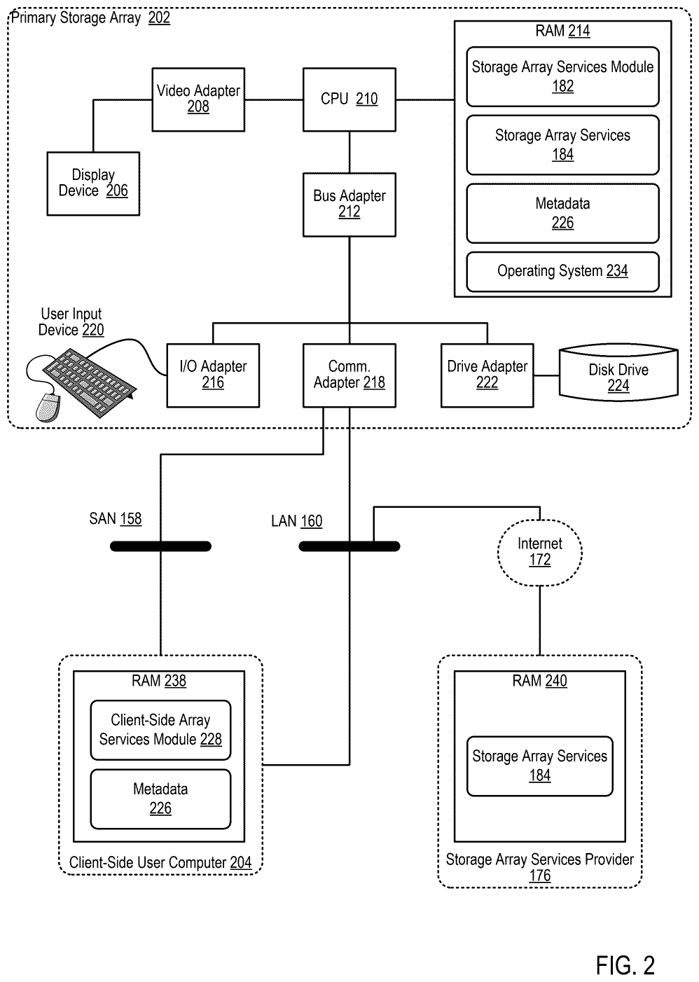

Locally providing cloud storage array services in accordance with embodiments of the present invention is generally implemented with computers. In the system of FIG. 1, for example, all the computing devices (164-170), storage arrays (102, 104), and storage array services provider (176) may be implemented to some extent at least as computers. For further explanation, therefore, FIG. 2 sets forth a block diagram of several example computers useful for locally providing cloud storage array services according to embodiments of the present invention. The example computers in FIG. 2 include a primary storage array (202), a client-side computer (204), and a storage array services provider (176). For clarity, only one computer, the primary storage array (202), in the example of FIG. 2 is depicted with a number of various computing components which are described below in greater detail. Readers will understand that the client-side user computer (204) and storage array services provider (176) may include similar components that operate in a similar manner.

The primary storage array (202) of FIG. 2 includes at least one computer processor (210) or ‘CPU’ as well as random access memory (214) (‘RAM’) which is connected through a high speed memory bus and bus adapter (212) to processor (210) and to other components of the primary storage array (202). Stored in RAM (214) is a storage array services module (182), a module of computer program instructions that, when executed, causes the primary storage array (202) of FIG. 2 to locally provide cloud storage array services when the storage array (202) is not connected to a remote cloud-based storage array services provider (172) by initiating one or more cloud storage array services (184) and locally providing the cloud storage array services including: generating, by the cloud storage array services, metadata (226) describing one or more real-time storage array characteristics; and presenting the metadata to a user through a local arca network.

Here, the user may receive or view the metadata (226) through a client-side array services module (228) stored in RAM (238) of a client-side user computer (204). In the example of FIG. 2, the client-side user computer (204) is depicted as being coupled through the SAN (158) to the storage array (202) for use in storing data in the storage array. Alternatively, the client-side user computer (204) may be a device that is not connected to the storage array (202) for purposes of storing data but rather may be connected only via a LAN for purposes of receiving results of the cloud storage array services. Consider, for example, a client-side user computer that is implemented as a mobile device that is carried by a system administrator. Although the mobile device is not coupled to the storage array for purposes of data storage, the system administrator may utilize the mobile device to request and receive results from various reporting services that indicate storage array performance characteristics, errors, alerts, and the like.

In some embodiments, prior to the storage array services module (182) initiating cloud storage array services (184) locally, such cloud storage array services may be provided remotely via the storage array services provider (176). In such an embodiment, the cloud storage array services (184) may be stored in RAM (24) of the storage array services provider (176) and be accessible via an API exposed by the storage array services provider via data communications over the Internet (172) or some other wide-area network.

Turning back to the components of the primary storage array (202), also stored in RAM (214) is an operating system (234). Examples of operating systems useful in primary storage arrays configured for locally providing cloud storage array services according to embodiments of the present invention include UNIX™, Linux™, Microsoft Windows™, and others as will occur to those of skill in the art. The operating system (234), the storage array services module (182), the cloud storage array services (184) and the metadata (226) in the example of FIG. 2 are shown in RAM (168), but many components of such software typically are stored in non-volatile memory also, such as, for example, on a disk drive (224). Likewise, the modules depicted in RAM (238, 240) of the client-side user computer (204) and the storage array services provider (176) may be stored in non-volatile memory.

The primary storage array (202) of FIG. 2 also includes disk drive adapter (222) coupled through an expansion bus and bus adapter (212) to the processor (210) and other components of the primary storage array (202). Disk drive adapter (222) connects non-volatile data storage to the primary storage array (202) in the form of disk drive (224). Disk drive adapters may be implemented in a variety of ways including as SATA (Serial Advanced Technology Attachment) adapters, PATA (Parallel ATA) adapters, Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example primary storage array (202) of FIG. 2 includes one or more input/output (‘I/O’) adapters (216). I/O adapters implement user-oriented input/output through, for example, software drivers and computer hardware for controlling output to display devices such as computer display screens, as well as user input from user input devices (220) such as keyboards and mice. The example primary storage array (202) of FIG. 2 also includes a video adapter (208), which is an example of an I/O adapter specially designed for graphic output to a display device (206) such as a display screen or computer monitor. Video adapter (208) is connected to the processor (210) through a high speed video bus.

The exemplary primary storage array (202) of FIG. 2 includes a communications adapter (218) for data communications with other computers (204, 176) through the Internet (172). Such data communications may be carried out through data communications networks such as IP data communications networks, and in other ways as will occur to those of skill in the art. Communications adapters implement the hardware level of data communications through which one computer sends data communications to another computer, directly or through a data communications network. Examples of such communications adapters useful include modems for wired dial-up communications, Ethernet (IEEE 802.3) adapters for wired data communications, and 802.11 adapters for wireless data communications.

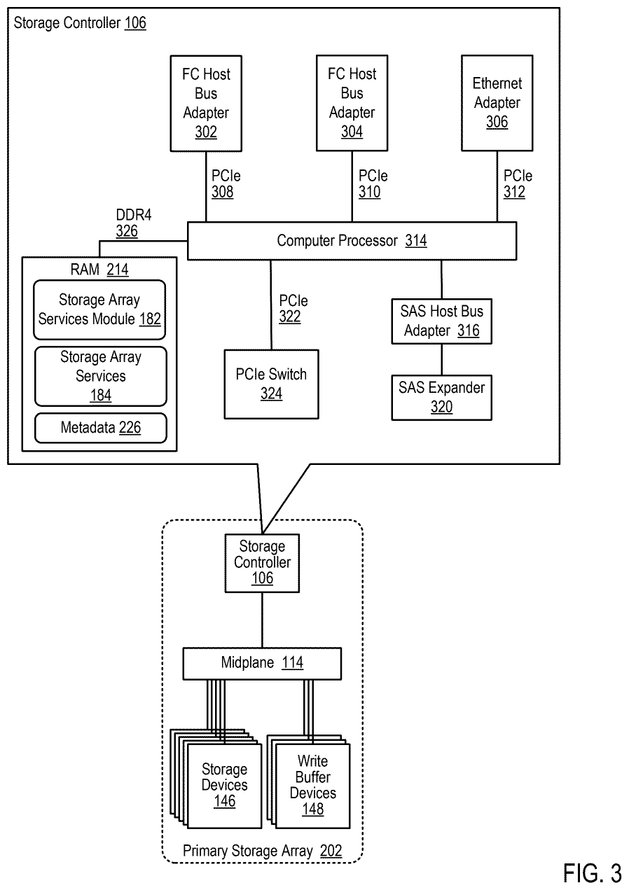

The example of FIG. 2 depicts a storage array implemented as one type of example computer. Readers of skill in the art will immediately recognize, however, that such a storage array useful for locally providing cloud storage array services in accordance with embodiments of the present invention may be implemented in a variety of different ways and include a variety of different components. To that end and for further explanation, FIG. 3 sets forth a block diagram of an example storage controller (106) of a primary storage array (202) configured for locally providing cloud storage array services in accordance with embodiments of the present invention. The example storage controller includes a computer processor (314). The computer processor is coupled to RAM (214) through a DDR4 (Double-Data Rate 4) bus. Stored in RAM (214) is a storage array services module (182) that operates as described above to locally provide one or more cloud storage array services (184) including the generation and presentation, to a user, of metadata (226) describing real-time storage array characteristics.

The processor (314) is also coupled for data communications through PCIe (Peripheral Component Interface express) links (308, 310, 312, 322) to several Fibre Channel host bus adapters (302, 304), an Ethernet adapter (306), and a PCIe switch (324). The Fibre Channel host bus adapters (308, 310) may couple the storage controller to a storage area network, such the SAN (158) depicted in the example of FIGS. 1 and 2. The Ethernet adapter (306) may couple the storage controller to a local area network such as the LAN (160) depicted in the example of FIGS. 1 and 2. The PCIe switch (324) may provide data communications across other PCI links through the midplane to PCI endpoints, such as storage devices or write buffer devices. Likewise, the processor (314) is also coupled through a SAS (Serial Attached SCSI) host bus adapter (316) to a SAS expander (320). The SAS expander may provide SAS connections between the computer processor (314) and other devices through the midplane.

Readers of skill in the art will recognize that these components, protocols, adapters, and architectures are for illustration only, not limitation. Such a storage controller may be implemented in a variety of different ways. Each such way is well within the scope of the present invention.

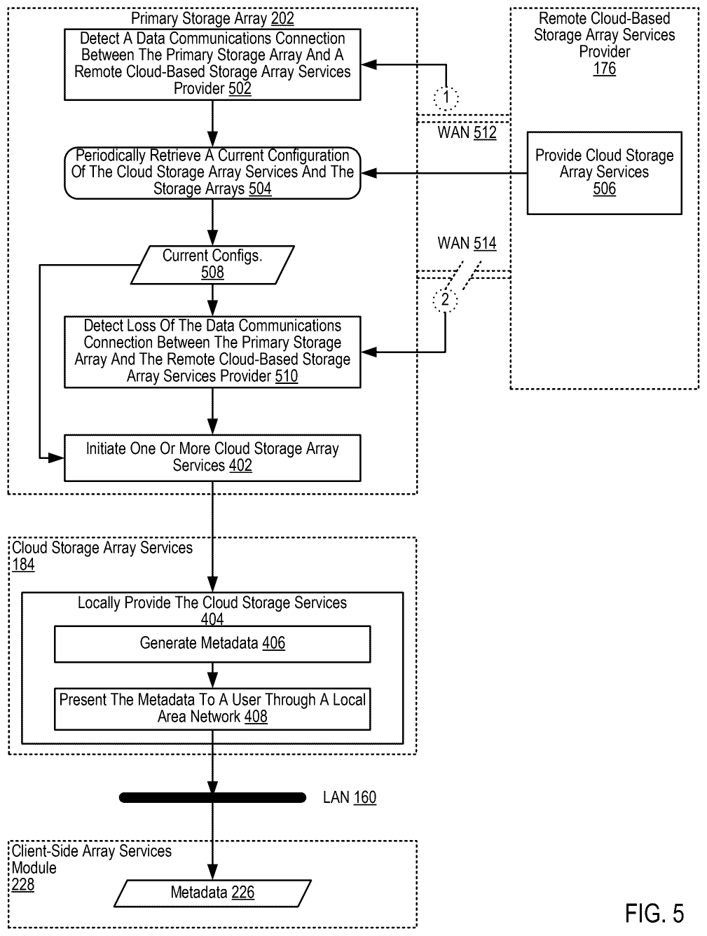

For further explanation, FIG. 5 sets forth a flow chart illustrating an exemplary method for locally providing cloud storage array services according to embodiments of the present invention. The method of FIG. 5 includes initiating (402), by a primary storage array (202), one or more cloud storage array services (184). Initiating (402) one or more cloud storage array services (184) may include deploying and executing one or more modules of computer program instructions.

The method of FIG. 5 also includes locally providing (404) the cloud storage array services (184). In the method of FIG. 5, locally providing (404) the cloud storage array services (184) is carried out by generating (406), by the cloud storage array services (184), metadata (226) describing one or more real-time storage array characteristics; and presenting (408) the metadata to a user through a local area network. Generating (406) such metadata may be carried out in various ways depending upon the type of service performed. In embodiments in which a service reports throughput of a storage array, the service may monitor a number of data storage write operations completed over a predefined period time. Such a number is metadata describing real-time storage array characteristics.

Presenting (408) metadata (226) locally to a user may be carried out by sending the data through the local area network (160) to a client-side array services module for presentation in a GUI (Graphical User Interface) (410). A client-side array services module (228) is a module of automated computing machinery comprising computer hardware, computer software, or a combination of computer hardware and software that is configured to receive and present in a GUI metadata from cloud storage array services. One example of a client-side array services module (228) may be a web browser and the GUI (410) may be a webpage hosted by the primary storage array (202). In another example, the client-side array services module (228) may be implemented as an application for a mobile device. These are but a few of many possible implementations of a client-side array services module (228) that may be configured to receive and present metadata to a user.

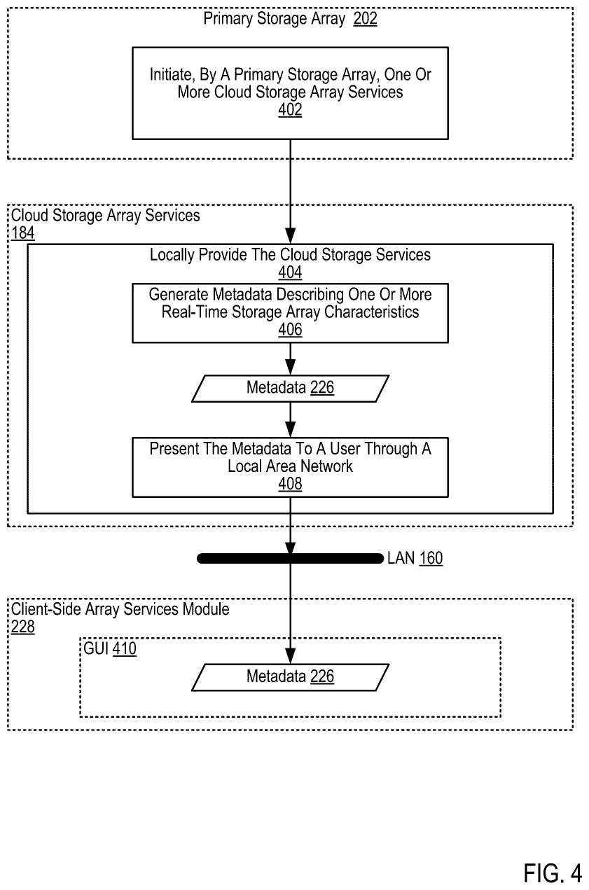

For further explanation, FIG. 5 sets forth a flow chart illustrating another method of locally providing cloud storage array services in accordance with embodiments of the present invention. The method of FIG. 5 is similar to the method of FIG. 4 including, as it does: initiating (402) one or more cloud storage array services (184) and locally providing (404) the cloud storage array services including: generating (406) metadata; and presenting (408) the metadata to a user through a local area network (160).

The method of FIG. 5 differs from the method of FIG. 5, however, in that the method of FIG. 5 also includes detecting (502), by the primary storage array (202) prior to initiating (402) the cloud storage array services (184), a data communications connection (512) between the primary storage array (202) and a remote cloud-based storage array services provider (176). Detecting (502) a data communications connection (512) between the primary storage array (202) and the remote cloud-based storage array services provider (176) may be carried out in a variety of manners. In one example, the primary storage array (202) may periodically ping the cloud-based storage array services provider (176). Each ping is returned by the cloud-based storage array services provider as long as a data communications connection over the wide area network (WAN) (512) is active.

While the data communications connection is active, the method of FIG. 5 includes providing (506), by the remote cloud-based storage array services provider (176), the cloud storage array services. The cloud-based storage array services provider (176) may provide many different types of cloud storage array services (184) in many different ways. In one example, the cloud-based storage array services provider (176) may expose an API to the primary storage array (and other storage arrays) where the API enables the performance of the cloud storage array services.

Also while the data communications connection between the primary storage array (202) and the remote cloud based storage array services provider (176) is active, the method of FIG. 5 may optionally include periodically retrieving (504), by the primary storage array from the remote cloud-based storage array services provider, a current configuration (508) of the cloud storage array services and a current configuration (508) of the plurality of storage arrays. The configuration of cloud storage array services may be updated over time by developers of the cloud storage array services and the configuration of the storage arrays in the data center may be updated by system administrators of the storage arrays or data center.

The method of FIG. 5 also includes detecting (508), by the primary storage array (202), loss of the data communications connection (514) between the primary storage array (202) and the remote cloud-based storage array services provider (176). Continuing with the heartbeat example described above, upon a predefined number of un-returned pings, the primary storage array (202) may infer a loss of data communications connection between the primary storage array (202) and the cloud-based storage area service provider (176). In an embodiment in which a data communication connection was previous active then is lost, the primary storage array (202) may be configured to initiate (402) the one or more cloud storage array services by the primary storage array only in response to detecting the loss of the data communications connection between the primary storage array and the remote, cloud-based storage array services provider.

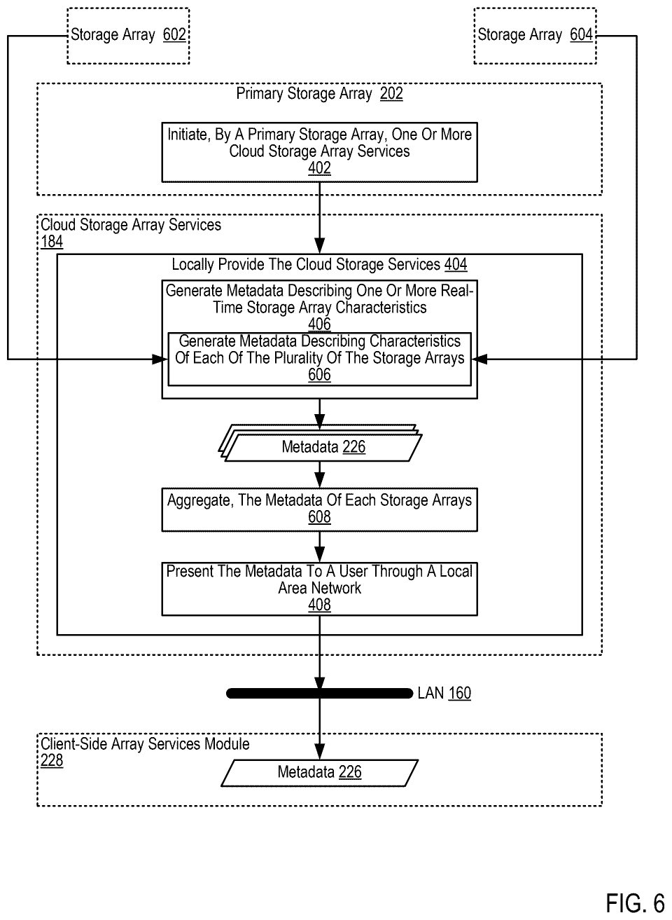

For further explanation, FIG. 6 sets forth a flow chart illustrating another method of locally providing cloud storage array services in accordance with embodiments of the present invention. The method of FIG. 6 is similar to the method of FIG. 4 including, as it does: initiating (402) one or more cloud storage array services (184) and locally providing (404) the cloud storage array services including: generating (406) metadata; and presenting (408) the metadata to a user through a local area network (160).

The method of FIG. 6 differs from the method of FIG. 5, however, in that in the method of FIG. 6, the data center includes a plurality of storage arrays (602, 604), including the primary storage array (202). Also, in the method of FIG. 5 generating (406) metadata (226) describing one or more real-time storage array characteristics includes: generating (606) metadata describing one or more real-time storage array characteristics of each of the plurality of the storage arrays (602, 604, 402) and aggregating (608), for presentation to the user, the metadata (226) of each of the plurality of storage arrays. In this way, cloud storage array services may be performed for a plurality of storage arrays in a single data center and all results are aggregated for presentation of a user.

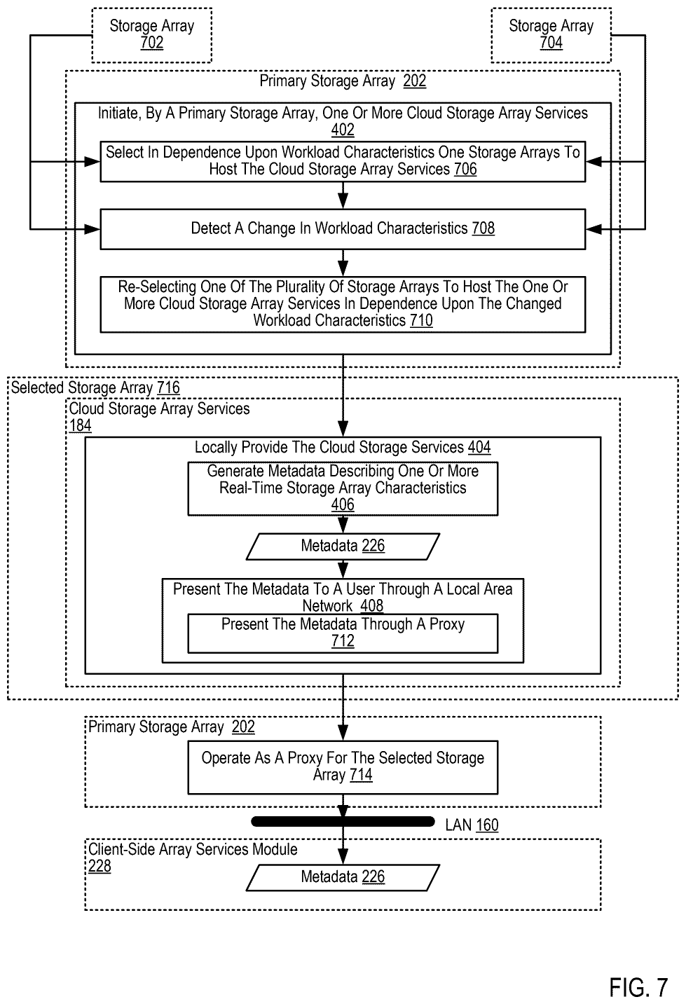

For further explanation, FIG. 7 sets forth a flow chart illustrating another method of locally providing cloud storage array services in accordance with embodiments of the present invention. The method of FIG. 7 is similar to the method of FIG. 4 including, as it does: initiating (402) one or more cloud storage array services (184) and locally providing (404) the cloud storage array services including: generating (406) metadata; and presenting (408) the metadata to a user through a local area network (160).

The method of FIG. 6 differs from the method of FIG. 5, however, in that in the method of FIG. 6, the data center includes a plurality of storage arrays (702, 704), including the primary storage array (202). The method of FIG. 7 differs from the method of FIG. 5 in that in the method of FIG. 7 initiating (402), by the primary storage array, one or more cloud storage array services (402) includes selecting (706), by the primary storage array (202) in dependence upon workload characteristics of each of the plurality of storage arrays (702, 704), one of the plurality of storage arrays to host the one or more cloud storage array services (184). Selecting a storage array to host the cloud storage array services in dependence upon workload characteristics may include retrieving from each of the storage arrays one or more metrics useful for inferring availability of processing capabilities and selecting the storage array with the greatest inferred availability of processing capabilities.

The method of FIG. 7 also includes detecting (708), by the primary storage array (202), a change in workload characteristics of each of the plurality of storage arrays and re-selecting (710) one of the plurality of storage arrays to host the one or more cloud storage array services in dependence upon the changed workload characteristics. The primary storage array (202) may be configured to periodically request workload characteristics from each of the plurality of storage arrays and determine if a change in the workload characteristics necessitates a change in selection of the storage array hosting the cloud storage array services (184).

The method of FIG. 7 also includes operating (714), by the primary storage array (202), as a proxy for the selected storage array (716) when the selected storage array (716) is not the primary storage array (202). Operating (714) as a proxy may take various forms. As mentioned above, the primary storage array (202) may operate as a proxy by receiving a final aggregated result of the performance of the cloud storage array services or may operate as a proxy by receiving, from each storage array independently, metadata streams generated as a result of the execution of the cloud storage array services by the selected storage array (716). In the latter example, the primary storage array (202) may process, analyze, and aggregate the various independent streams of metadata. To that end, presenting (408) the metadata to a user through a local area network in the method of FIG. 7 is carried out by presenting (712) the metadata through the proxy of the primary storage array (714).

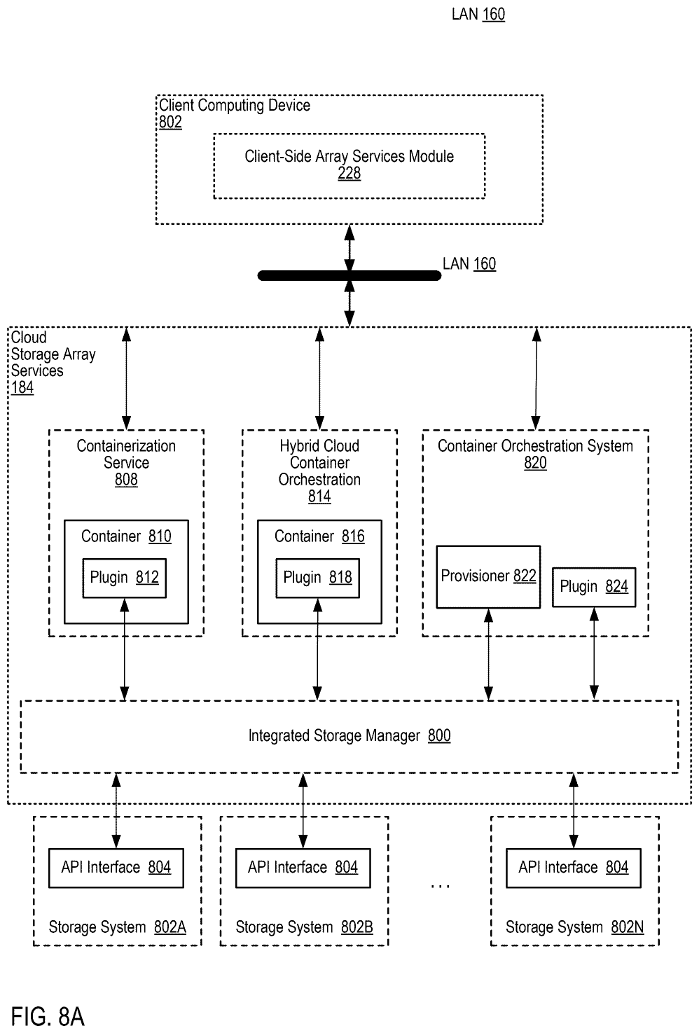

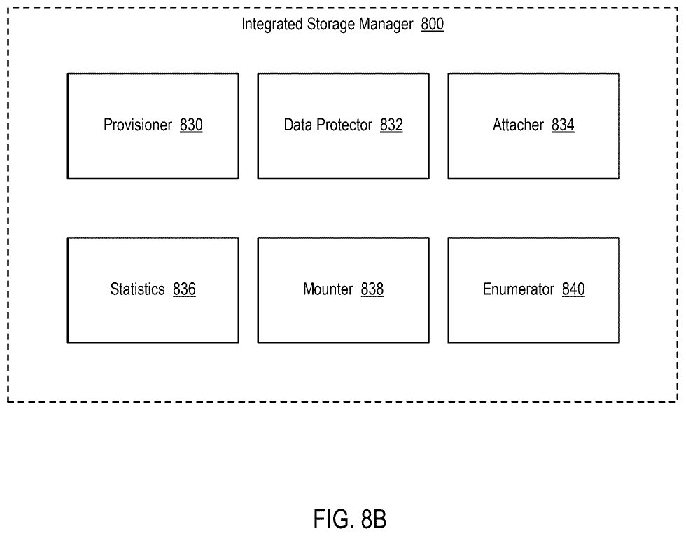

For further explanation, FIG. 8A illustrates an example computing environment for an integrated storage manager (800) operating between a plurality of storage systems and multiple container orchestrators—where the integrated storage manager (800) is implemented as part of the cloud storage array services (184) of a storage array services module (182) that locally provides cloud storage array services to one or more client computing devices.

In this example, a “storage system” may be considered to be a “storage array” as described above with reference to FIGS. 1-7, where a storage system (802A-802N) may be implemented similarly or equivalently to the storage arrays (102, 202).

In some implementations, the locally provided cloud storage services are provided in response to unavailability of remote cloud storage services, such as remote storage array services providers (176). However, in other examples, the locally provided cloud storage services (184) are provided whether or not the local plurality of storage systems are connected to a remote services provider.

As depicted within FIG. 8, a client computing device (802) may include a client-side array services module (228), such as described above with regard to FIGS. 1-7. Further, the client computing device (802) request and receive cloud storage array services (184)-where the cloud storage array services (184) may be implemented by a storage array services module (182) operating within one or more of the storage systems (802A-802N).

In some cases, the cloud storage array services (184) may be implemented within a storage array services module (182) that is a computing device (not depicted) other than the storage systems (802A-802N), where the computing device is on the same local network as the client computing device(s) (802) and the storage systems (802A-802N). In some implementations, as described above, any of the storage systems (802A-802N) may serve as the primary storage array (202).

Further, the cloud storage array services (184) may include virtualization services and/or operating system level virtualization services such as a containerization service (808), a hybrid cloud container orchestration (814), and/or a container orchestration system (820).

In some implementations, an integrated storage manager (800) may be in communication, across one or more networks (not depicted), with the storage systems (800A-800N) and with multiple different virtualization services, including services that provide operating system level virtualization, or containers-including containerization service (808), such as Docker™, hybrid cloud container orchestration (814), such as Mesosphere™, and Container Orchestration Service (820), such as Kubernetes™. In other examples, the integrated storage manager (800) may be in communication with other container service providers. Further, in this example, containerization service (808) may include multiple implementations of containers, including container(s) (810), which includes a plugin (812) for interfacing with the integrated storage manager (800), for example, via an API; hybrid cloud container orchestration (814) may include multiple implementations of containers, including container(s) (816), which includes a plugin (818) for interfacing with the integrated storage manager (800); and container orchestration system (820) may include a provisioner (822) and a plugin (824).

In some implementations, each of the storage systems (802A-802N) may include respective API interfaces (804), where the API interface (804) may be used for communicating with the integrated storage manager (800).

For further explanation, FIG. 8B illustrates an implementation of multiple components of an integrated storage manager (800). In this example, the integrated storage manager (800) may include multiple modules, including provisioner (830), data protector (832), attacher (484), statistics (836), mounter (838), and enumerator (840). In this example, provisioner (830) may provision storage system resources from among the connected storage systems, data protector (832) may implement one or more data security protocols, attacher (834) may attach or detach volumes within the containers or within the storage systems, statistics (836) may aggregate and calculate various performance metrics and data storage usage parameters and characteristics, mounter (838) may mount or unmount volumes within the containers or within the storage systems, and enumerator (840) may generate metadata for tracking or searching for data volumes, snapshots, or other data objects stored among the storage systems and containers.

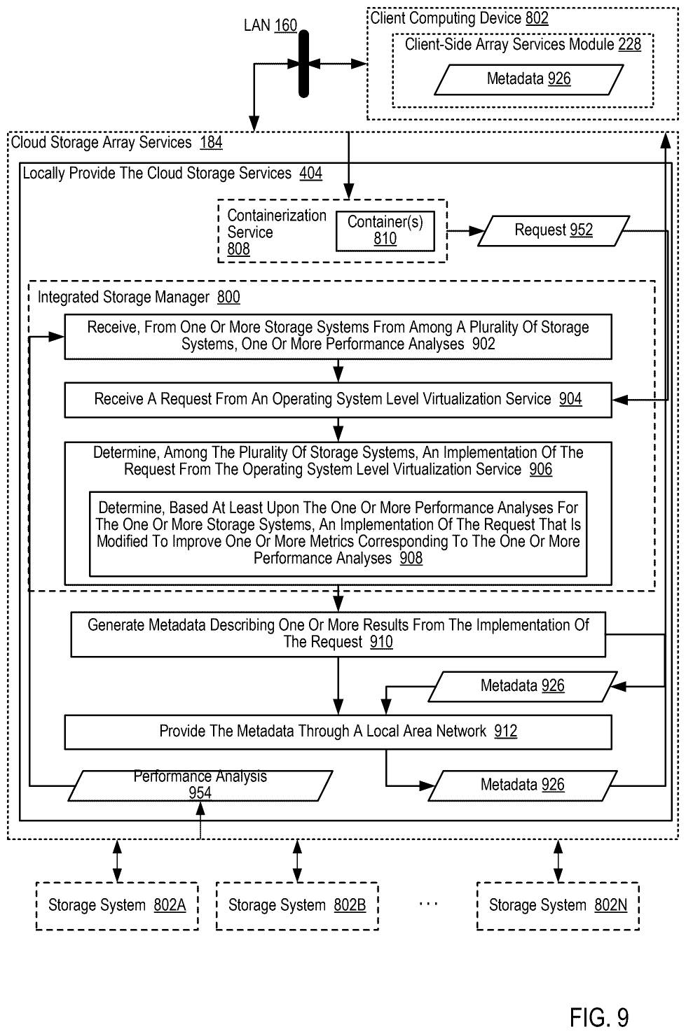

For further explanation, FIG. 9 sets forth a flow chart illustrating an example method for an integrated storage manager (800) according to some embodiments of the present disclosure. Although depicted in less detail, the example integrated storage manager (800) may be similar to the integrated storage managers described above with reference to FIGS. 8A or 8B, or any combination thereof.

In this example, the cloud storage array services (184) may locally provide the cloud storage services (404)-where the local cloud storage services (404) may include an integrated storage manager (800) configured to: receive (902), from one or more storage systems from among a plurality of storage systems (802A-802N), one or more performance analyses (954); receive (904) a management request (952) from an operating system level virtualization service (808); and determine (906), among the plurality of storage systems (802A-802N), an implementation of the request (952) from the operating system level virtualization service (808).

Receiving (902), from one or more storage systems from among a plurality of storage systems (802A-802N), one or more performance analyses (954) may be implemented by a storage system (802A-802N) sending metrics, such as performance metrics for the storage system, or an analysis of workload performance, across a network using API interface (804) to communicate with the API interface on the integrated storage manager (800).

Receiving (904) a request (952) from an operating system level virtualization service (808) may be implemented by the integrated storage manager (800) receiving one or more messages across a local network, local mesh fabric, or via a direct connection using one or more network communication protocols.

Determining (906), among the plurality of storage systems, an implementation of the request from the operating system level virtualization service (808) may be implemented by applying a selection policy to select one or more storage systems to provide storage and/or computing resources for implementing the request (952). In some examples, the selection policy may be configured to satisfy one or more of: balancing workload distributions across the plurality of storage systems (802A-802N), balancing data storage consumption across the plurality of storage systems (802A-802N), or satisfying one or more quality of service terms for a given client.

Further, in some implementations, determining (906) an implementation for the request (952) may include determining (908), based at least upon the one or more performance analyses (554) for the one or more storage systems, an implementation of the management request that is modified to improve one or more metrics corresponding to the one or more storage systems may be implemented by the integrated storage manager (800) determining multiple versions of a performance impact among the one or more storage systems based on implementing the management request in multiple ways, where the multiple ways include an implementation, such as provisioning, based on a performance analysis indicating a particular balance of workloads—where the determination, in this example, may be made to improve a performance balance of workloads among the one or more storage systems given a provisioning of data storage for a new workload among the one or more storage systems. For example, if the integrated storage manager (800) determines a particular one or more storage systems will be less lightly used, then those particular one or more storage systems may be selected for implementing the management request.

In other examples, the integrated storage manager (800) may be implemented to service bare metal applications as well as virtualized applications. In other examples, the integrated storage manager (800) may communicate with a management application for one or more storage services, such as a management application that runs in a cloud environment that manages the one or more storage systems (802A-802N). In other examples, the integrated storage manager (800) may receive analytics data from one or more containers, or Kubernetes pods or clusters at different granularities.

Further, in some examples, the integrated storage manager (800) may implement an agent (not depicted) within a host computer or some other computing device that is in communication with the one or more storage systems or containers, where the agent may provide an interface to one or more of the services provided by the integrated storage manager (800), including provisioning volumes or data, and mounting or unmounting volumes, and more generally for providing a host-side interface for each of the modules depicted in FIG. 8B. In some examples, the integrated storage manager (800) may provide information to the containerization service (808), the hybrid cloud container orchestration (814), and/or the container orchestration system (820), and/or the storage systems (802A-802N), where the recipients may use the information for scheduling workloads or data storage operations, balancing workloads, or other management functions for managing data storage.

Generating (910) metadata (926) describing one or more results from the implementation of the request (954) may be implemented similarly to generating (406) metadata describing one or more real-time storage array characteristics, as discussed above with reference to FIG. 4, where the metadata (926) may enable a GUI on a client device to provide information regarding success or failure, state changes, and/or consequences or effects of the implementation.

Providing (912) the metadata (926) through a local area network (160) may be implemented similarly to presenting (408) the metadata (226) to a user through a local area network, as discussed above with reference to FIG. 4.

Embodiments of the disclosure address challenges faced by customers operating storage systems within environments that lack external connectivity, commonly referred to as darksite environments. In conventional systems, cloud-based services provide functionality such as software upgrades, monitoring, incident response, and compliance reporting by relying on storage systems to transmit operational data to an external cloud service. Customers that cannot allow such connectivity are unable to take advantage of these services, resulting in reduced visibility, higher maintenance costs, and less efficient administration of their storage systems.

The disclosed embodiments provide an internal server that operates within a darksite environment to locally deliver cloud-like functionality. Storage systems communicate operational data to the internal server, which processes the data to determine the state of the storage systems and to identify maintenance actions such as upgrades, security patches, alerts, and compliance reporting. The internal server may execute defined workflows, generate update packages to enable self-service upgrades, and, when permitted, exchange reports or aggregated data with an external service to synchronize updates and advisories.

These embodiments provide technical improvements by enabling administration of storage systems in environments lacking external connectivity. Administrators gain automated, state-based recommendations without requiring external communications, thereby improving reliability, reducing manual effort, and enabling timely upgrades and security actions. The solution also improves the customer experience for darksite deployments, reduces costs associated with maintaining isolated environments, provides visibility into fleets of darksite storage systems, and may be offered as a standalone product that extends the full service experience to customers who cannot allow their systems to connect externally.

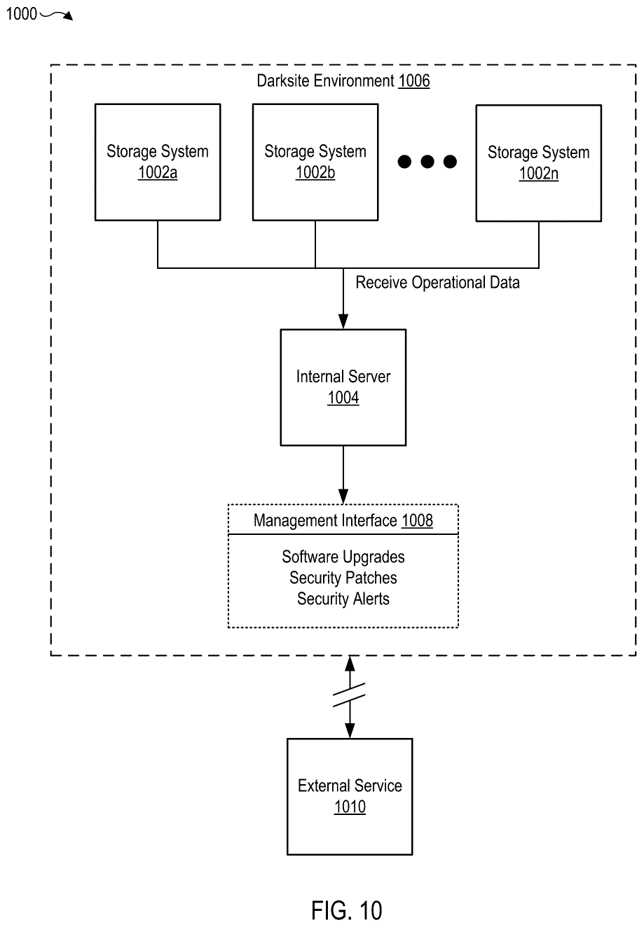

FIG. 10 is an illustration of an example architecture 1000 including internal server 1004 that provides maintenance actions for one or more storage systems 1002a-1002n deployed within a darksite environment 1006, in accordance with embodiments of the disclosure. For clarity, some components of architecture 1000 are not shown.

Storage systems 1002a-1002n may correspond to storage nodes, storage arrays, or other data storage devices configured to provide storage services within darksite environment 1006. Darksite environment 1006 may correspond to an environment lacking external connectivity, such as a secure or isolated network environment.

Internal server 1004 may be implemented as a physical or virtual server located within darksite environment 1006. Internal server 1004 may provide a management interface 1008, which may correspond to a graphical user interface, command line interface, or other interface that enables an administrator to manage storage systems 1002a-1002n. Internal server 1004 may also communicate with external service 1010 when connectivity is available. External service 1010 may correspond to a cloud-based or remote service that provides analysis, updates, or other functions for the storage systems 1002a-1002n.

In operation, internal server 1004 may receive operational data from storage systems 1002a-1002n. The operational data may include log files, performance metrics, or configuration data. In some embodiments, operational data may also include hardware health information, telemetry data, capacity and usage information, event data, firmware or software version information, security and compliance data, and topology or connectivity data.

Based on the operational data, internal server 1004 may process and determine a state of storage systems 1002a-1002n. As used herein, the state of one or more storage systems refers to information characterizing the operational condition, performance, configuration, or security posture of the storage systems. The state may include, without limitation, health information, performance information, capacity information, configuration information, security information, and compliance information.

Internal server 1004 may then generate information identifying one or more maintenance actions applicable to storage systems 1002a-1002n based on the determined state. Maintenance actions may include software upgrades, security patches, security alerts, or compliance reporting. For example, if the determined state indicates that a storage system is running a software version that is out of date, internal server 1004 may identify a maintenance action recommending a software upgrade for that storage system.

In some embodiments, internal server 1004 may execute defined workflows based on the operational data, such as a workflow to validate system health before performing an upgrade. In further embodiments, internal server 1004 may generate an update package configured to enable a self-service upgrade of one or more storage systems, where the update package may be staged and applied through management interface 1008. Internal server 1004 may also provide centralized management across multiple storage systems, enabling orchestration and coordination of tasks in a manner similar to cloud-based management solutions.

Internal server 1004 may present the generated information through management interface 1008, thereby enabling an administrator of darksite environment 1006 to manage storage systems 1002a-1002n without requiring direct connectivity to external service 1010.

It should be noted that internal server 1004 may be deployed in various topologies. In some embodiments, a single internal server 1004 supports multiple storage systems 1002a-1002n. In other embodiments, separate internal servers may be deployed in a distributed manner. The architecture of FIG. 10 is illustrative only and other configurations may be used.

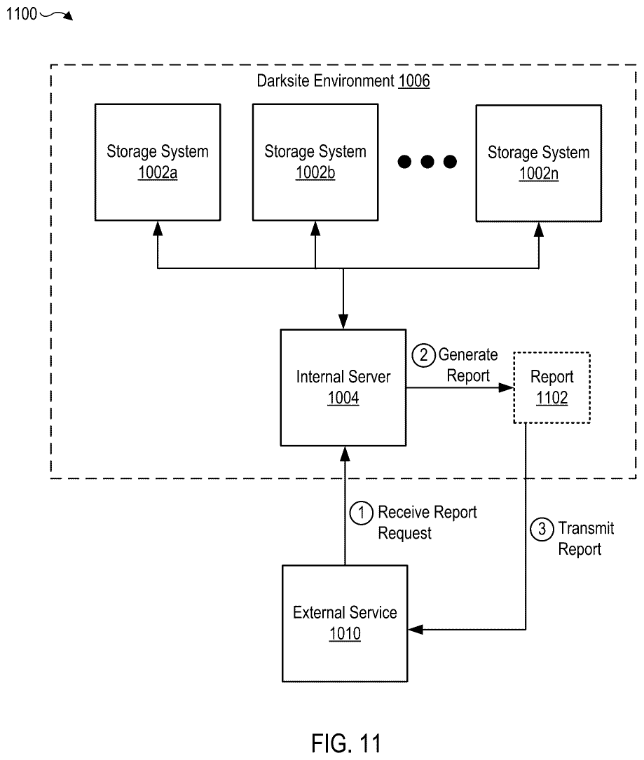

FIG. 11 is an illustration of an example architecture 1100 in which internal server 1004 exchanges information with external service 1010 through use of a report 1102, in accordance with embodiments of the disclosure. Architecture 1100 again includes storage systems 1002a-1002n in communication with internal server 1004 within darksite environment 1006. For clarity, some components of architecture 1100 are not shown.

In operation, external service 1010 may issue a request to internal server 1004 specifying information to be included in a report. Internal server 1004 may generate report 1102 based on operational data collected from storage systems 1002a-1002n, where the report may include information such as software version, configuration details, system status, or event logs. Internal server 1004 may then transmit report 1102 to external service 1010 using a permitted communication channel, which may include manual transfer of the report or opportunistic network connectivity.

External service 1010 may analyze report 1102 and generate a response that identifies one or more maintenance actions applicable to storage systems 1002a-1002n. In some embodiments, the response may specify available software upgrades, security patches, or security alerts. In other embodiments, the response may identify compliance issues with respect to defined security or regulatory requirements, or may provide a compliance status report reflecting the analyzed state of the storage systems.

Internal server 1004 may update the maintenance actions available through management interface 1008 based on the received response, thereby enabling an administrator to act on the identified information without requiring direct continuous connectivity to external service 1010.

Report 1102 and the response from external service 1010 are shown for illustrative purposes only and are not physical components of architecture 1100.

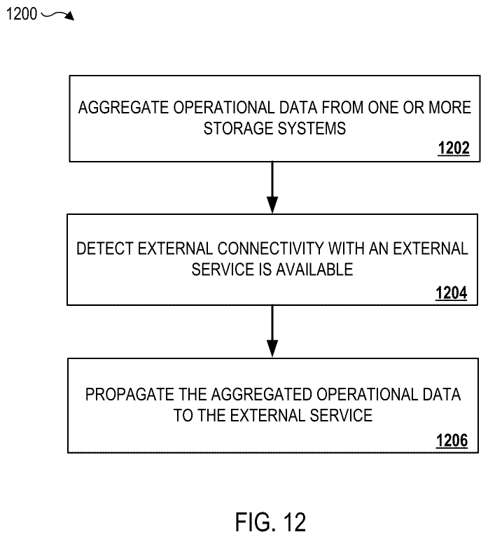

FIG. 12 is an example method 1200 illustrating an example method of propagating aggregated operational data to external service 1010 when connectivity becomes available, in accordance with embodiments of the disclosure. In general, method 1200 may be performed by processing logic that includes hardware, such as one or more processing devices, software executed on a processing device, or a combination of hardware and software. In some implementations, method 1200 is performed by processing logic of a processing device of internal server 1004 of FIG. 10.

At block 1202, internal server 1004 aggregates operational data received from storage systems 1002a-1002n. Aggregation may include combining log files, performance metrics, and configuration data across multiple storage systems into a consolidated dataset. In some embodiments, aggregation may also normalize or de-duplicate information to provide an overall view of the fleet of storage systems. For example, operational data may be aggregated to reflect the total available storage capacity across the systems, or to identify common firmware versions in use. Aggregated operational data may also summarize compliance-related information, such as whether each storage system conforms to a defined security baseline.

At block 1204, internal server 1004 detects that connectivity with external service 1010 is available. Connectivity may be detected through periodic network reachability tests, scheduled connection windows, or administrative indication that a temporary connection is permitted. In a darksite environment 1006, connectivity may only be available intermittently, for example through a secure gateway opened during maintenance windows. Detecting connectivity enables internal server 1004 to opportunistically transmit data when permitted, while otherwise continuing to operate locally.

At block 1206, internal server 1004 propagates the aggregated operational data to external service 1010. Propagation may include securely transmitting the aggregated data using encrypted channels or exporting the data for later upload through an out-of-band mechanism. External service 1010 may analyze the aggregated operational data to identify maintenance actions applicable to the storage systems. In some embodiments, the analysis may return recommendations for software upgrades, security patches, or security alerts. In other embodiments, external service 1010 may detect compliance issues with respect to defined security or regulatory requirements, and may provide a compliance status report summarizing the evaluation.

The embodiment of FIG. 12 illustrates a semi-connected operating mode in which internal server 1004 may opportunistically communicate with external service 1010 when network access is available. In this way, example architecture 1000 of FIG. 10 and example architecture 1100 of FIG. 11 may benefit from external analysis or services without requiring persistent connectivity.

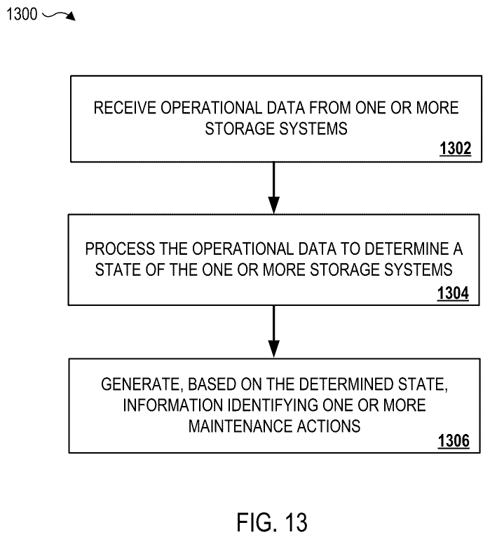

FIG. 13 is an example method 1300 illustrating an example method of generating maintenance actions from operational data in accordance with embodiments of the disclosure. In general, method 1300 may be performed by processing logic that includes hardware, such as one or more processing devices, software executed on a processing device, or a combination of hardware and software. In some implementations, method 1300 is performed by processing logic of a processing device of internal server 1004 of FIG. 10.

At block 1302, internal server 1004 receives operational data from one or more storage systems 1002a-1002n.

At block 1304, internal server 1004 processes the operational data to determine a state of the one or more storage systems.

At block 1306, internal server 1004 generates, based on the determined state, information identifying one or more maintenance actions applicable to the one or more storage systems. For example, if the state indicates that a storage system is running a software version that is out of date, a maintenance action may include recommending a software upgrade.

The embodiment of FIG. 13 illustrates the core functionality of internal server 1004 within darksite environment 1006. By receiving operational data, determining a state, and generating maintenance actions, internal server 1004 enables administration of storage systems in environments lacking external connectivity.

Advantages and features of the present disclosure can be further described by the following statements:
1. A method comprising receiving, by an internal server deployed within an environment lacking external connectivity, operational data from one or more storage systems; processing the operational data by the internal server to determine a state of the one or more storage systems; and generating, based on the determined state, information identifying one or more maintenance actions applicable to the one or more storage systems.
2. The method of statement 1, wherein the maintenance actions comprise one or more of software upgrades, security patches, or security alerts.
3. The method of any of statements 1-2, further comprising presenting the information through a management interface of the internal server to enable administration of the one or more storage systems without requiring direct connectivity to an external service.
4. The method of any of statements 1-3, further comprising generating, by the internal server, a report based on the operational data; transmitting the report from the internal server to an external service; receiving, by the internal server, a response from the external service based on the report; and updating the information based on the response.
5. The method of any of statements 1-4, further comprising receiving, by the internal server, a request from the external service specifying information to be included in the report.
6. The method of any of statements 1-5, further comprising propagating aggregated operational data from the internal server to an external service when external connectivity is available, the aggregated operational data being derived from the one or more storage systems.
7. The method of any of statements 1-6, wherein the internal server executes defined workflows based on the operational data.
8. The method of any of statements 1-7, further comprising generating an update package by the internal server based on the operational data, the update package being configured to enable a self-service upgrade of at least one storage system of the one or more storage systems.
9. The method of any of statements 1-8, wherein the operational data comprises one or more of log files, performance metrics, or configuration data.
10. The method of any of statements 1-9, wherein the processing further comprises identifying compliance issues of the one or more storage systems with respect to defined security or regulatory requirements.
11. The method of any of statements 1-10, further comprising generating a compliance status report by the internal server based on the operational data and defined security or regulatory requirements.

Exemplary embodiments of the present invention are described largely in the context of a fully functional computer system. Readers of skill in the art will recognize, however, that the present invention also may be embodied in a computer program product disposed upon computer readable media for use with any suitable data processing system. Such computer readable storage media may be any transitory or non-transitory media. Examples of such media include storage media for machine-readable information, including magnetic media, optical media, or other suitable media. Examples of such media also include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware, as hardware, or as an aggregation of hardware and software are well within the scope of embodiments of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method comprising:
receiving, by an internal server deployed within an environment lacking external connectivity, operational data from one or more storage systems;
processing the operational data by the internal server to determine a state of the one or more storage systems; and
generating, based on the determined state, information identifying one or more maintenance actions applicable to the one or more storage systems.

2. The method of claim 1, wherein the maintenance actions comprise one or more of software upgrades, security patches, or security alerts.

3. The method of claim 1, further comprising:
presenting the information through a management interface of the internal server to enable administration of the one or more storage systems without requiring direct connectivity to an external service.

4. The method of claim 1, further comprising:
generating, by the internal server, a report based on the operational data;
transmitting the report from the internal server to an external service;
receiving, by the internal server, a response from the external service based on the report; and
updating the information based on the response.

5. The method of claim 4, further comprising:
receiving, by the internal server, a request from the external service specifying information to be included in the report.

6. The method of claim 1, further comprising:
propagating aggregated operational data from the internal server to an external service when external connectivity is available, the aggregated operational data being derived from the one or more storage systems.

7. The method of claim 1, wherein the internal server executes defined workflows based on the operational data.

8. The method of claim 1, further comprising:
generating an update package by the internal server based on the operational data, the update package being configured to enable a self-service upgrade of at least one storage system of the one or more storage systems.

9. The method of claim 1, wherein the operational data comprises one or more of log files, performance metrics, or configuration data.

10. The method of claim 1, wherein the processing further comprises identifying compliance issues of the one or more storage systems with respect to defined security or regulatory requirements.

11. The method of claim 1, further comprising:
generating a compliance status report by the internal server based on the operational data and defined security or regulatory requirements.

12. An internal server comprising:
a memory; and
a processing device, operatively coupled to the memory, configured to:
receive, by the internal server deployed within an environment lacking external connectivity, operational data from one or more storage systems;
process the operational data by the internal server to determine a state of the one or more storage systems; and
generate, based on the determined state, information identifying one or more maintenance actions applicable to the one or more storage systems.

13. The internal server of claim 12, wherein the maintenance actions comprise one or more of software upgrades, security patches, or security alerts.

14. The internal server of claim 12, wherein the processing device is further configured to:
present the information through a management interface of the internal server to enable administration of the one or more storage systems without requiring direct connectivity to an external service.

15. The internal server of claim 12, wherein the processing device is further configured to:
generate, by the internal server, a report based on the operational data;
transmit the report from the internal server to an external service;
receive, by the internal server, a response from the external service based on the report; and
update the information based on the response.

16. The internal server of claim 15, wherein the processing device is further configured to:
receive, by the internal server, a request from the external service specifying information to be included in the report.

17. The internal server of claim 12, wherein the processing device is further configured to:
propagate aggregated operational data from the internal server to an external service when external connectivity is available, the aggregated operational data being derived from the one or more storage systems.

18. The internal server of claim 12, wherein the internal server executes defined workflows based on the operational data.

19. The internal server of claim 12, wherein the processing device is further configured to:
generate an update package by the internal server based on the operational data, the update package being configured to enable a self-service upgrade of at least one storage system of the one or more storage systems.

20. A non-transitory computer readable storage medium storing instructions which, when executed, cause a processing device of an internal server to:
receive, by the internal server deployed within an environment lacking external connectivity, operational data from one or more storage systems;
process the operational data by the internal server to determine a state of the one or more storage systems; and
generate. based on the determined state. information identifying one or more maintenance actions applicable to the one or more storage systems.
